(19) United States
(12) Patent Application Publication
(10) Pub. No.: US 2018/0302680 A1
(43) Pub. Date: Oct. 18, 2018

(54) On-Demand Video Surfing

(71) Applicant: Google Inc., Mountain View, CA (US)

(72) Inventor: Neil P. Cormican, Menlo Park, CA (US)

(73) Assignee: Google Inc., Mountain View, CA (US)

(21) Appl. No.: 15/381,997

(22) Filed: Dec. 16, 2016

(51) Int. Cl. H04N 21/472; H04N 21/45; H04N 21/482; H04L 29/06; H04N 21/44; H04N 21/8352; H04N 21/439; G06F 17/30

(52) U.S. Cl. CPC H04N 21/47202; H04N 21/4532; H04N 21/4828; H04L 65/4084; G06F 17/30784; H04N 21/8352; H04N 21/4394; H04N 21/47217; H04N 21/44008

(57) ABSTRACT

This document describes methodologies for on-demand video surfing. These techniques and apparatuses improve navigation for VOD content by using a search query to search the VOD content for videos having a specified type of scene (e.g., hook). Further, the user can surf through the videos, similar to channel surfing television channels via a video-rendering device. However, the video-rendering device navigates directly to a scene of the specified type in each video based on the search query. This allows the user to surf through purposefully chosen moments in the videos. Then, any of the selected videos can automatically continue playing through to the end of the video or, based on a user input, restart at the beginning of the video.

### BACKGROUND

Television viewers frequently engage in “channel surfing”, which is the process of quickly scanning through different television channels to find content of interest. Channel surfing live television can result in a user stumbling across a “hook” (e.g., a scene of interest) in television content that grabs the user's attention and prompts the user to continue watching. One problem with channel surfing is that the user may skip a channel currently showing a commercial during a program in which the user may have interest. The user may also skip a channel having content of interest if a show on that channel is currently at a scene that does not grab the user's attention, even though the user may enjoy the overall show.

In contrast to live television, when users browse video on-demand (VOD) content using an On-demand Service (e.g., Netflix®, Play®, HBO®), the users are generally required to rely on arbitrary factors, such as cover art, ratings, a description, and other metadata to decide whether to watch a particular movie or show. Because the number of available movies and shows is so great, users are subjected to the paradox of choice, which results in many users spending greater amounts of time browsing than actually watching a show because they are unsure as to what exactly they want to watch.

These problems are time consuming to users, and in many cases can lead to user frustration. To avoid choosing a video that the user may not enjoy, users frequently spend extended amounts of time browsing information about various shows rather than actually watching a show.

This background description is provided for the purpose of generally presenting the context of the disclosure. Unless otherwise indicated herein, material described in this section is neither expressly nor impliedly admitted to be prior art to the present disclosure or the appended claims.

### BRIEF DESCRIPTION OF THE DRAWINGS

Apparatuses of and techniques using methodologies for on-demand video surfing are described with reference to the following drawings. The same numbers are used throughout the drawings to reference like features and components:

FIG. 1 illustrates an example environment in which methodologies for on-demand video surfing can be embodied.

FIG. 2 illustrates an example implementation of a computing device of FIG. 1 in greater detail in accordance with one or more embodiments.

FIG. 3 illustrates an example implementation of time-shifting on-demand content in accordance with one or more embodiments.

FIG. 4 illustrates an example scenario of navigating time-shifted on-demand content in accordance with one or more embodiments.

FIG. 5 illustrates an example implementation of time-shifting on-demand content in accordance with one or more embodiments.

FIG. 6 illustrates an example implementation of navigating time-shifted on-demand content in accordance with one or more embodiments.

FIG. 7 illustrates example methods of navigating media content using methodologies for on-demand video surfing in accordance with one or more embodiments.

FIG. 8 illustrates example methods for navigating media content using methodologies for on-demand video surfing in accordance with one or more embodiments.

FIG. 9 illustrates various components of an electronic device that can implement methodologies for on-demand video surfing in accordance with one or more embodiments.

### DETAILED DESCRIPTION

### Overview

Conventional techniques that allow users to channel surf through video on-demand (VOD) content are inefficient at least because users may only rely on descriptive text that fails to accurately portray content in a video. This form of content browsing to find content of interest is time consuming, and users frequently spend more time browsing the descriptive text than actually viewing content of interest.

The methodologies for on-demand video surfing described herein improve navigation for VOD content by using a search query specifying types of scenes (e.g., hooks), which increases a likelihood of catching the user's attention. Further, when resultant videos are provided to a client device, the videos are time-shifted according to the hooks. For instance, a server can stream a time-shifted video to the client device beginning at a particular scene, or the server can transmit a mark to the client device indicating a location of the scene in the video to enable the client device to jump directly to the scene when the video is played.

In this way, the user can surf through the videos in a manner similar to channel surfing television channels, but with the client device navigating directly to scenes of the specified type in each video based on the search query. This avoids browsing certain moments in the videos that have a low likelihood of catching the user's attention, and allows the user to surf through purposefully chosen moments in the videos. Further, these techniques reduce time spent browsing for content of interest or time spent surfing through on-demand content in comparison to conventional techniques. These techniques further allow playback of any of the videos to automatically continue through to the end of the video or, based on a user input, restart at a beginning of the video.

As used herein, the term “hook” may refer to a scene designed to catch a user's attention. For example, an action movie can include scenes with thrilling action, such as explosions or car chases, that grab a user's interest and prompt the user to continue watching. Movie trailers frequently use hooks or portions of hooks that show users a very dramatic or exciting moment in the movie in an attempt to encourage the users to watch a particular movie. The hook can be chosen by a service provider or studio, or can be selected based on one or more factors, such as spikes on social media while the video aired, extracted clips uploaded to a content sharing website (e.g., Youtube®), crowd volume in a live sporting event, and so on. Accordingly, a hook can include a wide variety of hooks designed to grab the user's attention, and can be selected based on audience interaction or feedback.

As used herein, the term “time-shift” refers to playing a video at a time other than time zero (e.g., a beginning of the video). Time-shifting can be performed in a variety of different ways. Some examples include: streaming a video to a client device beginning at a location that is not at time zero of the video, identifying a mark associated with the video that is usable to skip to a specified location in the video, or identifying a location in the video that is not at time zero and which indicates a beginning of a portion of the video that is transmittable to the client device for playback. Other examples are also contemplated, and are discussed in further detail below. Accordingly, the term “time-shift” can refer to a variety of different ways to cause a video to be initiated for playback at a time other than time zero.

The following discussion first describes an operating environment, followed by techniques and procedures that may be employed in this environment. This discussion continues with an example electronic device in which methodologies for on-demand video surfing can be embodied.

### Example Environment

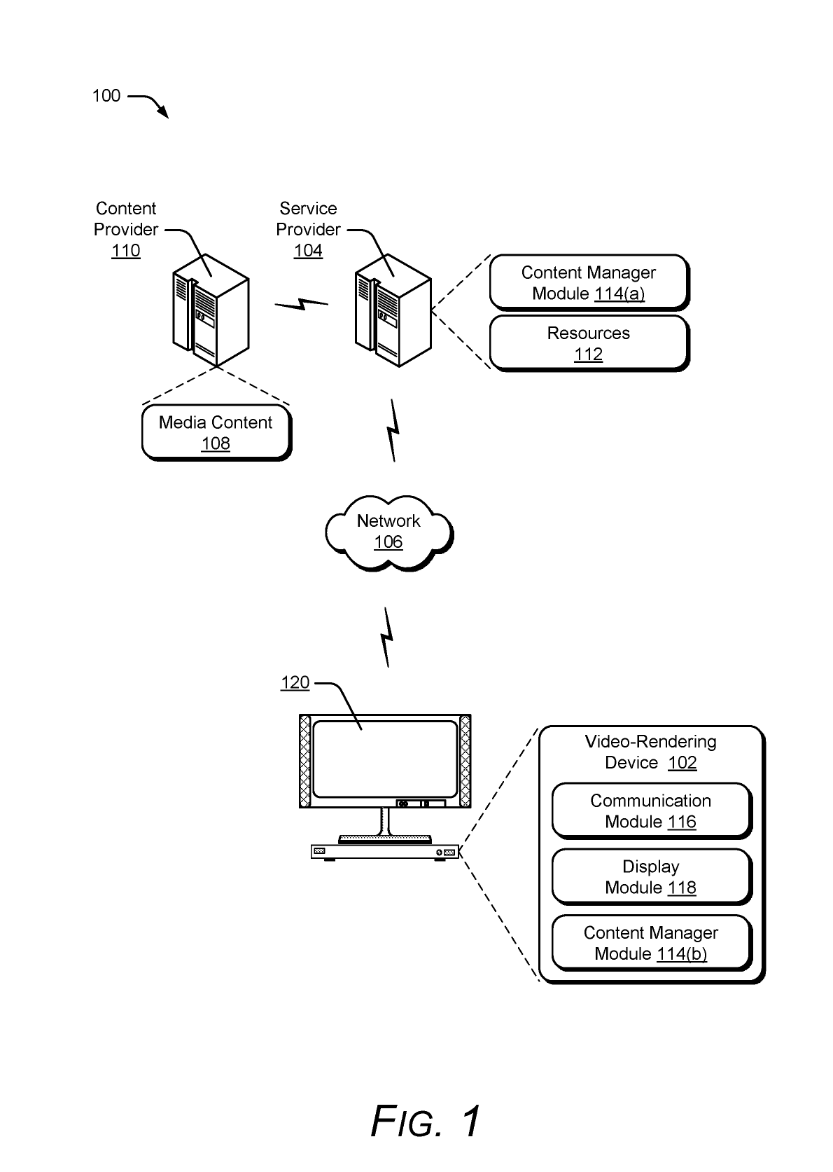

FIG. 1 illustrates an example environment 100 in which methodologies for on-demand video surfing can be embodied. The example environment 100 includes examples of a video-rendering device 102 and a service provider 104 communicatively coupled via a network 106. Functionality represented by the service provider 104 may be performed by a single entity, may be divided across other entities that are communicatively coupled via the network 106, or any combination thereof. Thus, the functionality represented by the service provider 104 can be performed by any of a variety of entities, including a cloud-based service, an enterprise hosted server, or any other suitable entity.

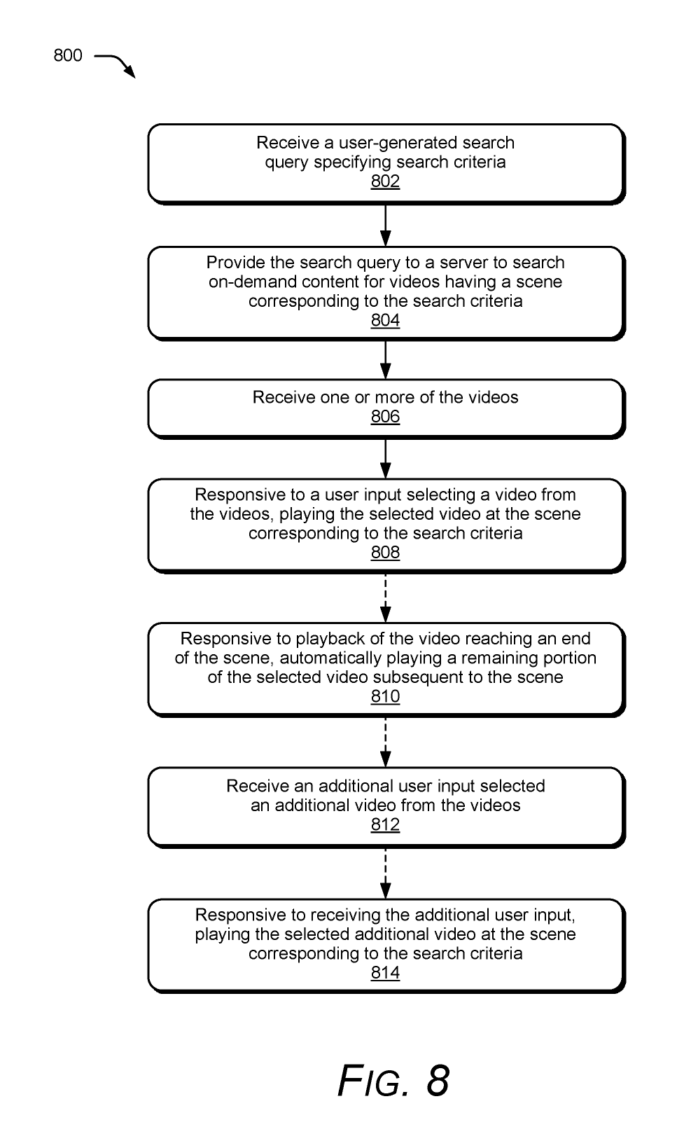

Computing devices that are used to implement the service provider 104 or the video-rendering device 102 may be configured in a variety of ways. Computing devices, for example, may be configured as a desktop computer, a laptop computer, a mobile device (e.g., assuming a handheld configuration such as a tablet or mobile phone), and so forth. Additionally, a computing device may be representative of a plurality of different devices, such as multiple servers of the service provider 104 utilized by a business to perform operations “over the cloud” as further described in relation to FIG. 8.

The service provider 104 is representative of functionality to distribute media content 108 obtained from one or more content providers 110. Generally speaking, the service provider 104 is configured to make various resources 112 available over the network 106 to clients, such as the video-rendering device 102. In the illustrated example, the resources 112 can include program content or VOD content that has been processed by a content controller module 114(a). In some implementations, the content controller module 114(a) can authenticate a user to access a user account that is associated with permissions for accessing corresponding resources, such as particular television stations or channels, from a provider. The authentication can be performed using credentials (e.g., user name and password) before access is granted to the user account and corresponding resources 112. Other resources 112 may be available without authentication or account-based access. The resources 112 can include any suitable combination of services and/or content typically made available over a network by one or more providers. Some examples of services include, but are not limited to: a content publisher service that distributes content, such as streaming videos and the like, to various computing devices, an advertising server service that provides advertisements to be used in connection with distributed content, and so forth. Content may include various combinations of assets, video comprising part of an asset, advertisements, audio, multi-media streams, animations, images, television program content such as television content streams, applications, device applications, and the like.

The content controller module 114(a) is further configured to manage content requested by the video-rendering device 102. For instance, the video-rendering device 102 can receive a search query from a user, and transmit the search query to the service provider 104 to search for a particular genre of movie. The content controller module 114(a) represents functionality to perform a search for media content matching search criteria of the search query. Then, results of the search can be communicated to the video-rendering device 102 to enable the user of the video-rendering device 102 to view media content matching the search criteria. As is discussed in more detail below, the content controller module 114(a) is configured to identify specific scenes in the resultant media content, and time-shift the results according to the specific scenes matching the search criteria to enable the computing device to navigate between the videos from specific scene to specific scene.

The content provider 110 provides the media content 108 that can be processed by the service provider 104 and subsequently distributed to and consumed by end-users of computing devices, such as video-rendering device 102. Media content 108 provided by the content provider 110 can include streaming media via one or more channels, such as one or more programs, on-demand videos, movies, and so on.

Although the network 106 is illustrated as the Internet, the network may assume a wide variety of configurations. For example, the network 106 may include a wide-area-network (WAN), a local-area-network (LAN), a wireless network, a public telephone network, an intranet, and so on. Further, although a single network 106 is shown, the network 106 may be representative of multiple networks. Thus, a variety of different networks 106 can be utilized to implement the techniques described herein.

The video-rendering device 102 is illustrated as including a communication module 116, a display module 118, and a content manager module 114(b). The communication module 116 is configured to communicate with the service provider 104 to request particular resources 112 and/or media content 108. The display module 118 is configured to utilize a renderer to display media content via a display device 120. The communication module 116 receives the media content 108 from the service provider 104, and processes the media content 108 for display.

The content manager module 114(b) represents an instance of the content manager module 114(a). The content manager module 114(b) is configured to manage local media content based on search queries received at the video-rendering device 102. For example, the content management module 114(a) represents functionality to perform a search for local media content that matches search criteria of the search query. Then, results of the search can be presented to the user via the display device 120 of the video-rendering device 102 to enable the user of the video-rendering device 102 to view local media content matching the search criteria. As is discussed in more detail below, the content controller module 114(b) is configured to identify specific scenes in the local media content based on the search query, and time-shift the results according to the specific scenes to enable navigation between the results from specific scene to specific scene.

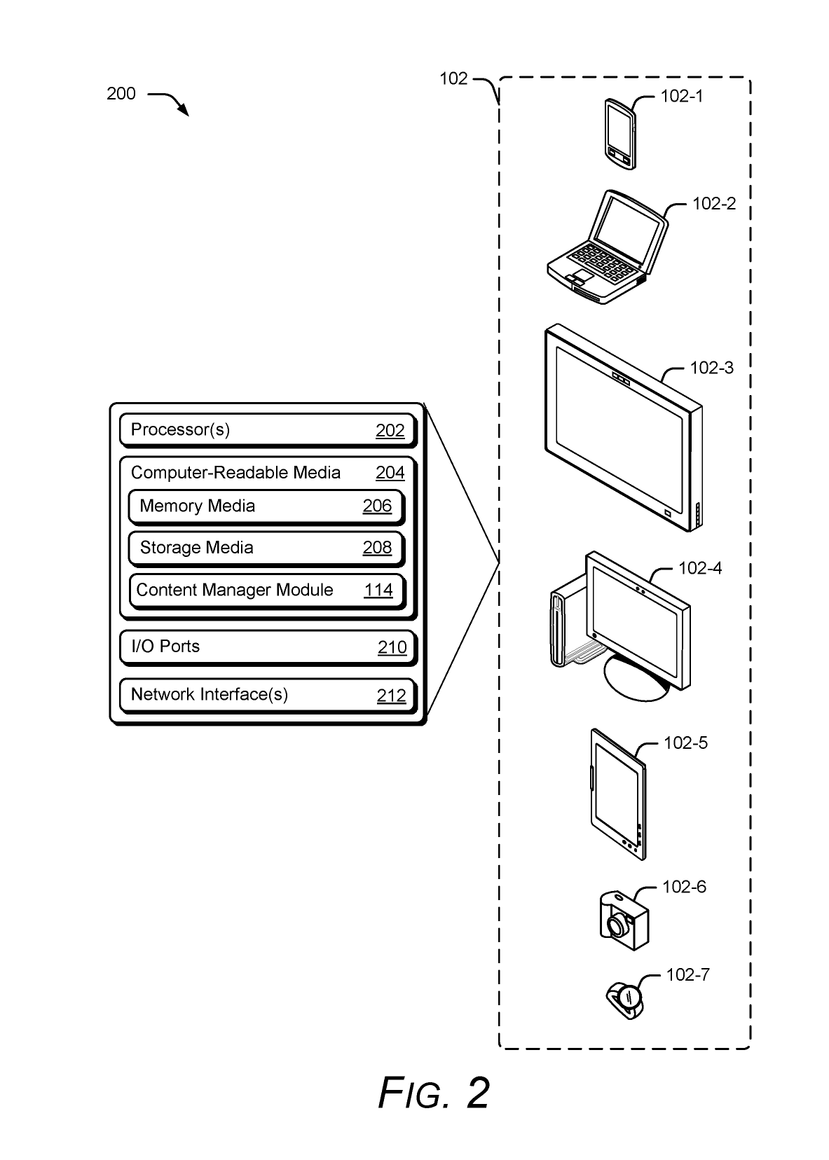

Having generally described an environment in which methodologies for on-demand video surfing may be implemented, this discussion now turns to FIG. 2, which illustrates an example implementation 200 of a client device, such as the video-rendering device 102 of FIG. 1, in greater detail in accordance with one or more embodiments. The video-rendering device 102 is illustrated with various non-limiting example devices: smartphone 102-1, laptop 102-2, television 102-3, desktop 102-4, tablet 102-5, camera 102-6, and smartwatch 102-7. The video-rendering device 102 includes processor(s) 202 and computer-readable media 204, which includes memory media 206 and storage media 208. Applications and/or an operating system (not shown) embodied as computer-readable instructions on the computer-readable media 204 can be executed by the processor(s) 202 to provide some or all of the functionalities described herein, as can partially or purely hardware or firmware implementations. The computer-readable media 204 also includes the content manager module 114, which can search for and provide on-demand content that is time-shifted according to specific scenes matching search criteria of a search query.

The video-rendering device 102 also includes I/O ports 210 and network interfaces 212. I/O ports 210 can include a variety of ports, such as by way of example and not limitation, high-definition multimedia interface (HDMI), digital video interface (DVI), display port, fiber-optic or light-based, audio ports (e.g., analog, optical, or digital), USB ports, serial advanced technology attachment (SATA) ports, peripheral component interconnect (PCI) express based ports or card slots, serial ports, parallel ports, or other legacy ports. The video-rendering device 102 may also include the network interface(s) 212 for communicating data over wired, wireless, or optical networks. By way of example and not limitation, the network interface 212 may communicate data over a local-area-network (LAN), a wireless local-area-network (WLAN), a personal-area-network (PAN), a wide-area-network (WAN), an intranet, the Internet, a peer-to-peer network, point-to-point network, a mesh network, and the like.

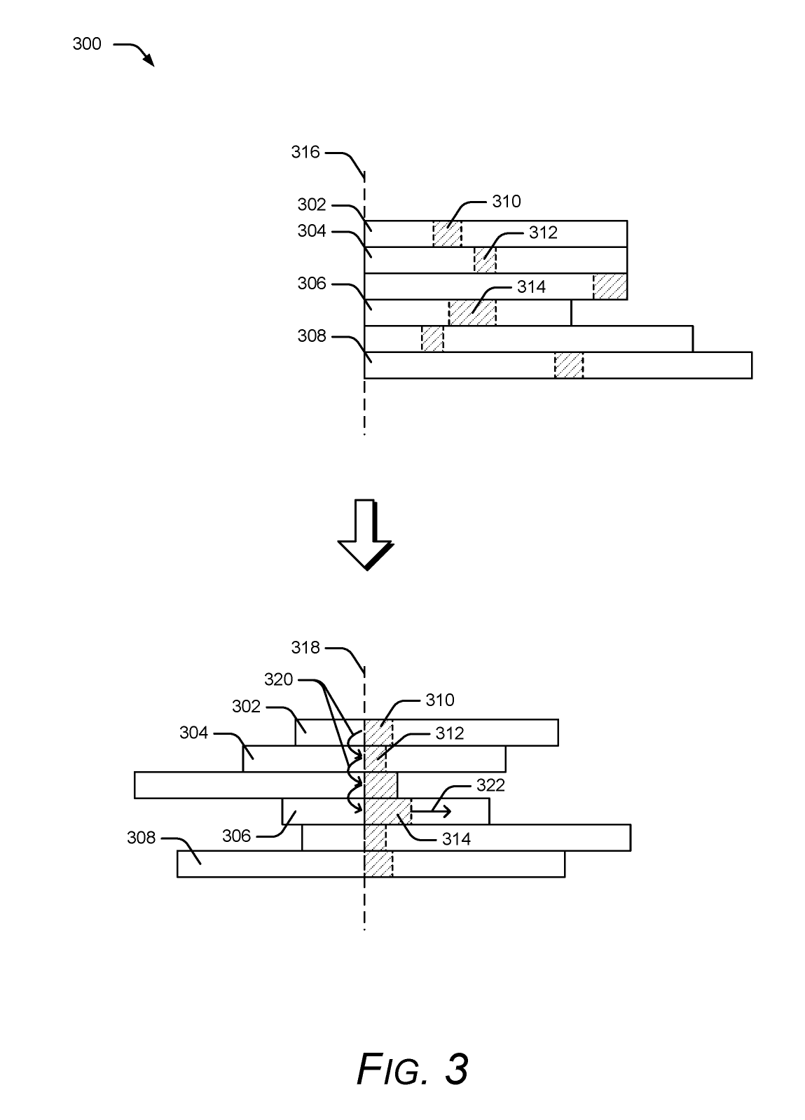

Having described the video-rendering device 102 of FIG. 1 in greater detail, this discussion now turns to FIG. 3, which illustrates an example implementation 300 of time-shifting streaming content in accordance with one or more embodiments. Similar to channel surfing, “on-demand surfing” is the process of scanning through different VOD content to find videos of interest. On-demand video surfing provides functionality, via the video-rendering device 102, to browse through and preview different videos based on specific hooks in the videos. In implementations, a user may enter a search query to initiate a search for particular hooks or type of hooks (also referred to herein as “scene type”). For example, the search query can specify a type of action or event occurring in a scene. Some examples of hooks include explosions, car chases, romantic scenes, first fights, scoring plays in a sporting event, interviews with a particular celebrity, and so on. Accordingly, by entering the search query, the user may determine the type of hook that is to be viewed. In implementations, video image recognition techniques can be used to identify different portions of the videos that correspond to different types of hooks, such as a particular scene with an explosion, a scene including a particular actor, a scene in which a particular actor speaks or is injured, a scene in which a particular team scores a goal, and so forth. Accordingly, any suitable video image recognition technique can be utilized to analyze, identify, and tag different portions of a video as including a specific type of hook.

In the example implementation 300, a search has been performed to identify multiple on-demand videos each having a scene corresponding to search criteria of a search query. One or more identified videos are provided as a content stream. For example, a first stream includes video 302, a second stream includes video 304, another stream includes video 306, and yet another stream includes video 308. Any number of videos can be provided as content streams. Because the videos are provided as content streams, the user can navigate (vertically in the illustrated example) between the videos.

Each of the identified videos includes a particular scene (e.g., hook) that matches the search criteria of the search query. For example, video 302 includes scene 310 represented by hash marks that identify a beginning and an ending of the scene. In addition, video 304 includes scene 312, video 306 includes scene 314, and so forth. The identified scenes 310, 312, 314 include a similar type of content but differ in actual content. Further, the identified scenes 310, 312, 314 can include different durations of time and can be located at different times in the videos 302, 304, 306, respectively, in comparison to one another. For example, scene 314 has a longer relative time duration than scenes 310, 312, and scene 312 has the shortest relative time duration among the scenes 310, 312, 314. In another example, the scene 310 may begin at time 10:32 while the scene 312 begins at time 13:17 and the scene 314 begins at time 11:40. Some scenes may be located near the beginning of a respective video while other scenes are located near the end of the respective video. Accordingly, each scene can be located at any of a variety of locations within the respective video.

Initially, the videos are aligned based on a beginning of each video, such as at alignment point 316, which is set at time zero for each video. Allowing the user to navigate between the streams at this point would result in navigating to the beginning (e.g., time zero) of each video. One problem with this is that the first several minutes of many movies generally includes information related to a production company, titles, logos, opening credits, and so on. None of this information, however, is likely to be a hook, particularly a hook corresponding to the search criteria.

In at least one implementation, the content management module 114 is configured to realign the videos in the content streams based on the identified hooks. In the illustrated example, the on-demand content (e.g., videos 302, 304, 306) is time-shifted and aligned based on the identified hooks (e.g., scenes 310, 312, 314). Because the videos include different content, the videos are aligned at alignment point 318, which is at different times in each video. The alignment point 318 allows navigation to particular moments in each video. For example, video 302 is aligned to scene 310, video 304 is aligned to scene 312, video 306 is aligned to scene 314, and so on.

In another example implementation, the identified videos can include video identities (IDs) that are provided to the client device. Then, a user input via the client device can select a video ID to request that a corresponding video begin streaming for display at the client device. Alternatively, the service provider 104 can provide a corresponding video file to the client device based on the selected video ID. In at least one example, a portion of the video file beginning at the scene is sent to the client device for playback. Alternatively, an entire video file can be sent to the client device along with a mark specifying a location (e.g., alignment point 318) of the scene in the video file. The client device can then use the mark to jump directly to the scene corresponding to the search criteria.

In implementations, video 302 is selected to initiate playback. Rather than playing the video 302 at the beginning (e.g., time zero), the video 302 automatically begins playing at scene 310. If the user desires to browse to a next video, the video-rendering device 102 can navigate (e.g., navigation 320) to the next stream and begin playback of the video 304 directly at scene 312. Accordingly, the techniques described herein for on-demand video surfing allow navigation 320 directly to a hook in each video. Although navigation 320 is illustrated in a single direction, the video-rendering device 102 can also navigate in the reverse direction, jump to a particular video, skip a video, return to a previous video, or any combination thereof. Accordingly, the navigation 320 is not limited to a unidirectional navigation.

Further, playback of each video is not limited to playback of the identified scene (e.g., hook). For example, rather than playing the hook in a first video and then automatically jumping to a next video's hook, the playback of the first video automatically continues after the hook is completed. In the illustrated example, assume the user enjoys the scene 314 of the video 306 such that the user desires to continue viewing the video 306. In this case, the playback of the video 306 automatically continues after reaching the end of the scene 314 to play back a remaining portion of the video subsequent to the scene, as is represented by arrow 322. In addition, subsequent to the playback being initiated and responsive to a user selection of a user interface instrumentality, the video-rendering device 102 can navigate to time zero of the video 306 to view the video 306 from the beginning. Also, at any time during the playback of the video 306, the user can navigate to the hook in a video of the next stream.

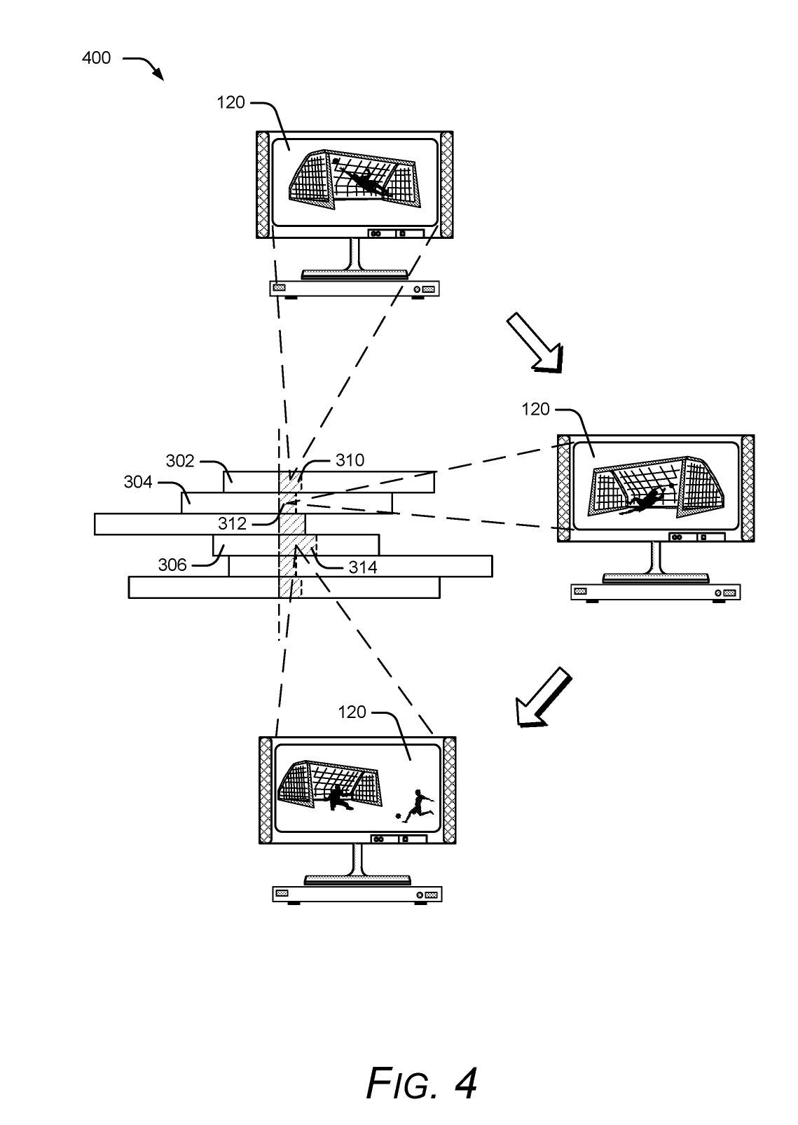

FIG. 4 illustrates an example scenario of navigating time-shifted on-demand content in accordance with one or more embodiments. Assume the search query is for “goals scored in soccer last night”. Various soccer videos matching the search query are obtained and time-shifted to allow navigation between the soccer videos at locations corresponding to goals scored in each of those soccer games. For example, the computing device initiates playback of video 302 at scene 310, which includes a goal being scored. The scene is presented via the display device 120 of the video-rendering device 102. At any point prior to, at, or after the end of scene 310, a user input initiates navigation to video 304 and scene 312 is automatically presented via the display device 120. The scene 312 shows another goal being made in a different soccer game. Further navigation occurs and causes scene 314 to be presented, which shows yet another goal being made in yet another soccer game (e.g., video 306). The user can skip around to any of the different soccer games based on the scenes matching the search query.

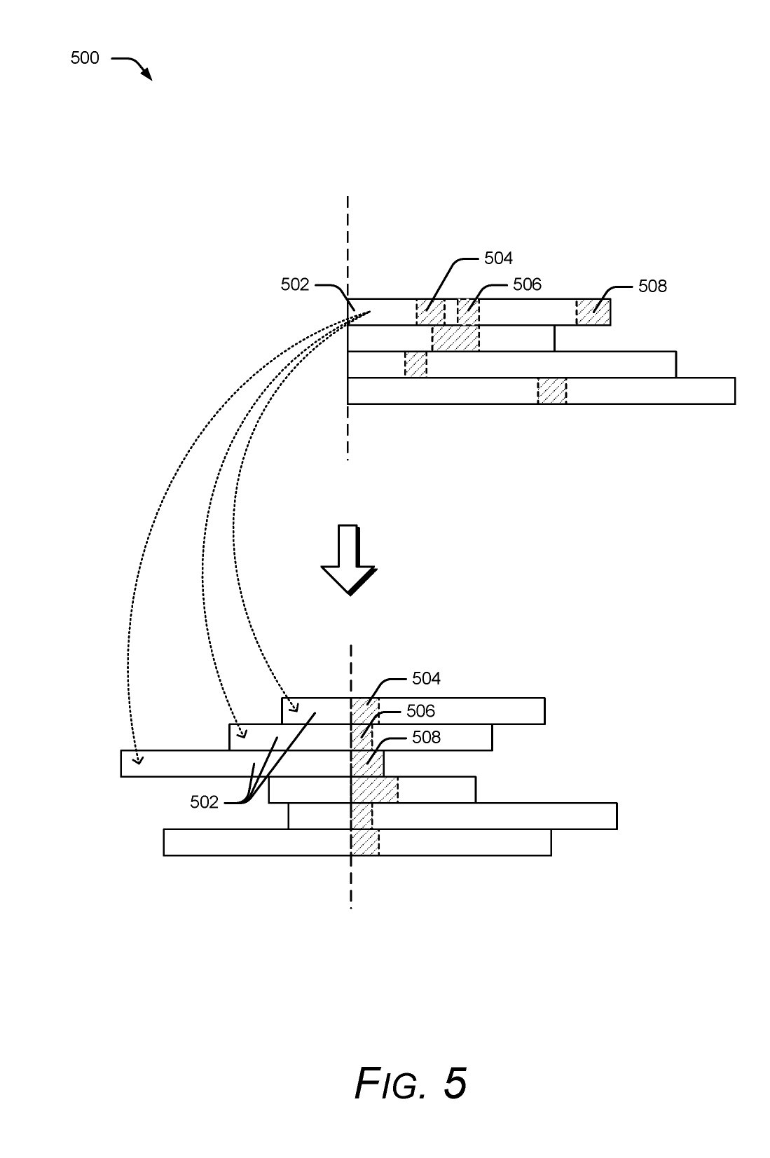

FIG. 5 illustrates an example implementation 500 of time-shifting on-demand content in accordance with one or more embodiments. In some instances, a single video can include multiple scenes matching the search criteria, and the resultant content streams can include a subset of streams corresponding to a same video but relative to different scenes. In the illustrated example, video 502 includes scenes 504, 506, and 508 that each match the search criteria.

In implementations, the content management module 114 can generate multiple streams corresponding to the video 502, where an instance of the video 502 in each stream is time-shifted according to a different hook. In the illustrated example, the video 502 is provided in three separate streams based on the three identified scenes 504, 506, 508. A first stream is provided that includes an instance of the video 502 time-shifted based on the scene 504, a second stream is provided that includes an instance of the video 502 time-shifted based on the scene 506, and a third stream is provided that includes an instance of the video 502 time-shifted based on scene 506. This enables navigation between the scenes 504, 506, 508 from the same video 502. This further enables playback to continue after any of the scenes 504, 506, 508, rather than automatically navigating to or playing back a next hook. In implementations, navigation to a next hook is responsive to a user navigation input.

In at least one implementation, the video 502 can include multiple marks that indicate a respective location of each scene 504, 506, 508. These marks can be provided to the client device to enable the client device to jump to locations associated with one or more of the scenes 504, 506, 508. Thus, the client device can initiate playback of the video 502 at any of the scenes 504, 506, 508, and navigate between the scenes 504, 506, 508 in the video 502. From the user perspective, the client device simply skips to specific scenes in the video 502 that correspond to the search query.

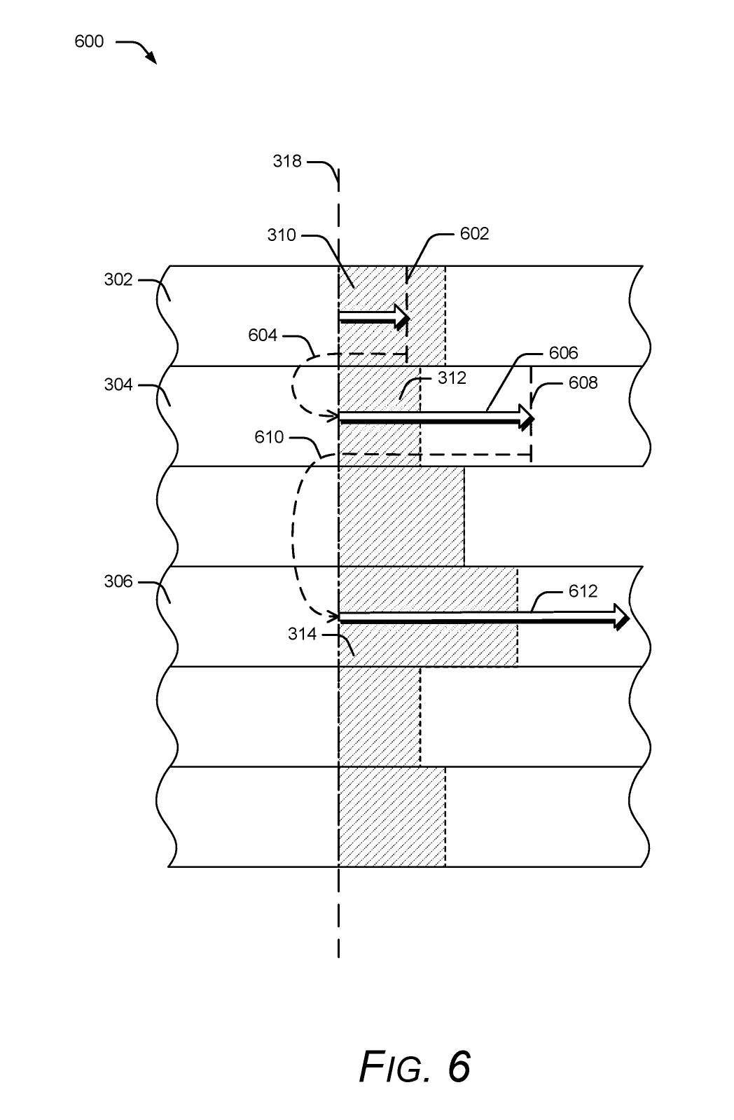

FIG. 6 illustrates an example implementation of navigating time-shifted on-demand content in greater detail in accordance with one or more embodiments. As mentioned above, navigation between the videos can occur at any point in time prior to, at, or after the end of the hook. Continuing with the above example from FIGS. 3 and 4, assume playback begins at alignment point 318 corresponding to scene 310 of video 302. At time 602, which is prior to completing playback of the scene 310, a user input is received to navigate to a next stream. Consequently, the content manager module 114 causes playback of the video 302 to cease, and navigates (e.g., arrow 604) to the next stream to cause playback of video 304 to begin at scene 312. The user may become interested in the video 304 based on scene 312, and allows the playback (e.g., arrow 606) of the video 304 to continue past scene 312.

At some point after scene 312, the user becomes disinterested in the video 304 and decides to navigate to another video. Thus, a user input is received at time 608, and the video-rendering device 102 navigates (e.g., arrow 610) to scene 314 of video 306. Accordingly, navigation between the streams can occur at any point in time, and there is no minimum or maximum time required for viewing before navigation is allowed. Further, as illustrated by arrow 610, navigation can skip one or more streams, and is not limited to sequential or linear navigation in a list of streams. In the illustrated example, the user becomes interested in video 306 based on scene 314 and allows playback to continue after the scene 314. Accordingly, playback 612 of the video 306 continues until the end of the video 306, or until receiving a user input that initiates navigation to yet another stream or otherwise ceases playback 612 of the video 306.

Using the techniques described herein, users can easily and efficiently navigate directly to specific types of hooks in on-demand videos, based on a user-generated search query. At least some of the on-demand videos can be accessible via an on-demand service or local storage. Browsing the hooks of the videos enables the user to more easily decide which video to continue watching than by using conventional techniques, at least because the user can immediately view specific parts of the videos that are most likely to grab his attention.

### Example Methods

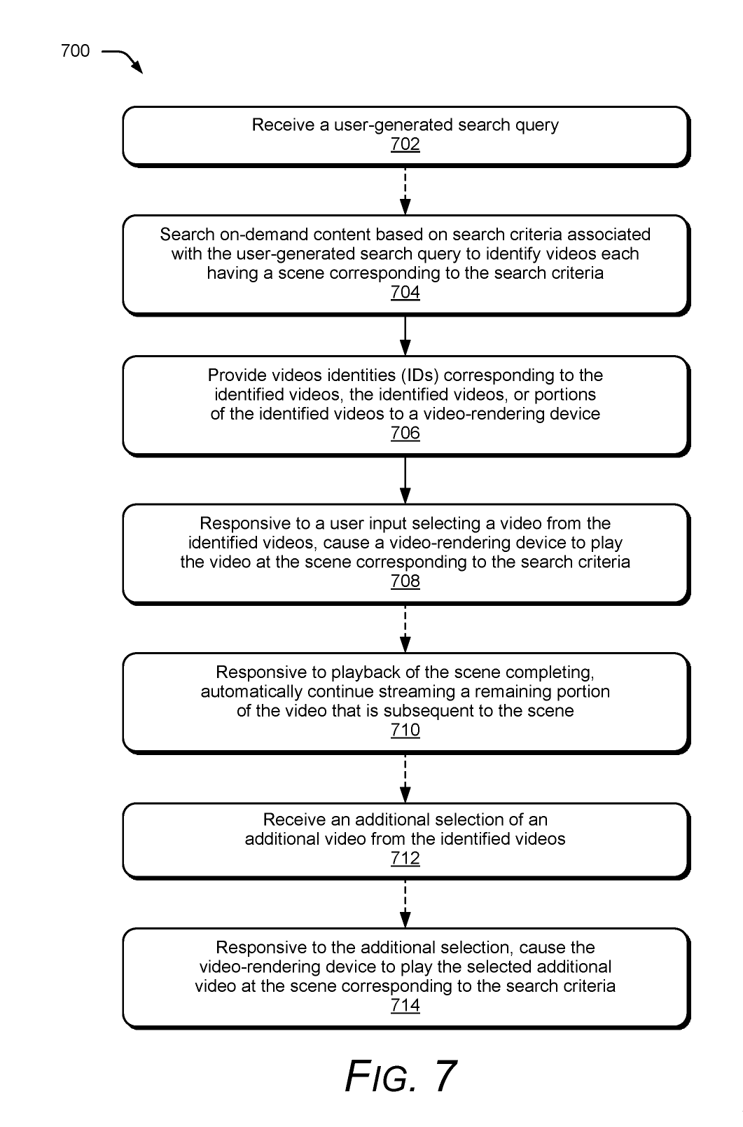

The following discussion describes methods by which techniques are implemented to enable use of methodologies for on-demand video surfing. These methods can be implemented utilizing the previously described environment and example systems, devices, and implementations, such as shown in FIGS. 1-6. Aspects of these example methods are illustrated in FIGS. 7 and 8, which are shown as operations performed by one or more entities. The orders in which operations of these methods are shown and/or described are not intended to be construed as a limitation, and any number or combination of the described method operations can be combined in any order to implement a method, or an alternate method.

FIG. 7 illustrates example methods 700 of navigating media content using methodologies for on-demand video surfing in accordance with one or more embodiments. At 702, a user-generated search query is received. In implementations, the search query is received based on a user input, such as an audio (e.g., voice) input. For example, the user may say “show me explosions”, “show me puppies”, or “show me interviews with [insert public figure]”, and so on. The video-rendering device 102 can recognize the user's voice commands and convert an associated audio signal into the search query. In at least one implementation, the user input can be based on selection of a menu item, icon, or object displayed via a user interface presented on the display device 120 of the video-rendering device 102 or on a display device of a remote controller.

At 704, on-demand content is searched based on search criteria associated with the search query to identify videos having at least one scene corresponding to the search criteria. For example, the service provider 104 searches the on-demand content based on the search query. Video image recognition techniques can be used to identify and label scenes in the on-demand content. In implementations, metadata associated with the on-demand content can include information identifying different scenes according to different scene type based on events occurring in these scenes. The video-rendering device 102 or the service provider 104 can search the metadata and/or the on-demand content to locate videos matching the search criteria.

At 706, video identities (IDs) corresponding to the identified videos, the identified videos, or portions of the identified videos are provided to the video-rendering device. For example, the service provider 104 can provide IDs to enable the video-rendering device 102 to select one or more of the videos for playback, such as via a content stream. In implementations, the service provider 104 can also provide an indication (e.g., mark) that specifies a location of the scene in a video that corresponds to the search criteria. A separate indication can be provided for each video identified based on the search. The indication is configured to enable the client device to jump directly to the location of the scene in the video when the video is selected for playback. In at least one implementation, the service provider 104 provides the video IDs to the video-rendering device 102, which allows the service provider 104 to provide a particular video responsive to a user input selecting a corresponding video ID.

At 708, responsive to a user input selecting a video ID associated with one of the videos, the video-rendering device is caused to play the video at the scene. In implementations, the service provider 104 can begin streaming the video to the video-rendering device 102 beginning at the scene. In other implementations, the service provider 104 can provide the video to the video-rendering device 102 to allow the video-rendering device 102 to skip directly to the scene by using the mark and play the video at the scene.

Optionally at 710, a remaining portion of the video that is subsequent to the scene is automatically streamed in response to completion of playback of the scene. By continuing streaming the video, the service provider 104 can cause the video-rendering device 102 to play the remaining portion of the video without interruption. In this way, a user of the video-rendering device 102 is not limited to watching only the scene, but can continue watching the video past the end of the scene.

Optionally at 712, an additional selection of an additional video ID associated with an additional video is received. For instance, during playback of a first video, a user of the video-rendering device 102 decides to navigate to another video, and thus selects a second video ID via a user interface at the video-rendering device 102. This selection of the second video ID is received at the service provider 104 for processing.

At 714, the video-rendering device is caused to play the additional video at the scene corresponding to the search criteria in response to the additional selection. For instance, the service provider 104 can provide a second video to the video-rendering device 102 via a separate content stream from the first video. Alternatively, the service provider 104 can provide the second video to the video-rendering device 102 along with a mark that identifies the location of the scene in the second video that matches the search criteria. Providing this information enables the video-rendering device 102 to skip to the scene in the second video when playing the second video.

FIG. 8 illustrates example methods 800 of navigating media content using methodologies for on-demand video surfing in accordance with one or more embodiments. At 802, a user-generated search query specifying search criteria is received. For instance, a client device receives a user input, such as a voice input or selection of a user interface instrumentality presented via a display device of the client device. At 804, the search query is provided to a server to search on-demand content for videos having a scene corresponding to the search criteria.

At 806, one or more of the videos are received at the client device. For instance, the videos can be received via a content stream. In implementations, the videos can be time-shifted such that the videos are playable directly at the scene corresponding to the search criteria in each video. For example, if the search query was for explosions, then the videos are aligned to each scene having an explosion. Then, when the user navigates to a particular video, the scene with the explosion is presented, rather than the beginning of the video. Alternatively, at least a portion of the videos can be downloaded at the client device to enable the client device to play a portion of a video beginning at the scene. In yet other embodiments, a mark associated with a respective video is received that indicates a location of the scene in the respective video. This mark is usable by the client device to jump directly to the specific location of the scene in the video.

At 808, a selected video is played at the scene corresponding to the search criteria in response to a user input selecting the video. For instance, a user can select one of the videos via a user interface of the client device, such as via a list, an icon, an image, or object. The client device begins playing the video at the scene by using the mark to jump directly to the location of the scene in the video. Alternatively, the client device can receive the selected video as streaming content that begins at the location of the scene.

Optionally at 810, a remaining portion of the selected video subsequent to the scene is automatically played in response to playback of the video reaching an end of the scene. For instance, playback of the video is not limited to the scene only, but the client device can continue playing the video past the end of the scene and through to the end of the video. Optionally at 812, an additional user input is received that selects an additional video. For instance, a user may select a different video ID via the user interface to initiate playback of a different video. At 814, the selected different video is played at the scene corresponding to the search criteria in response to receiving the additional user input. In this way, the user can surf through a variety of different on-demand videos at scenes corresponding to the user-generated search query, and can allow any of the videos to continue playing past the end of the scene and through to the end of the video or play a selected video from the beginning.

These methodologies allow a user to surf through different on-demand videos in an easy and efficient manner Using these techniques, the user can preview purposefully chosen scenes in each video that are likely to grab the user's attention, rather than simply read a description of the video, or view a movie trailer of the video. Furthermore, those purposefully chosen scenes are based on a user-generated search query, which represents the user specifying the type of hook that he is interested in at that moment in time. Additionally, playback of the video is not limited to those particular scenes, but the playback can continue through the end of the video. Moreover, surfing through the on-demand content in this way allows the user to essential assess a production quality of the video based on the viewed scene. Accordingly, these methodologies and techniques provide a variety of functionalities that improve conventional techniques used to navigate on-demand content.

### Example Electronic Device

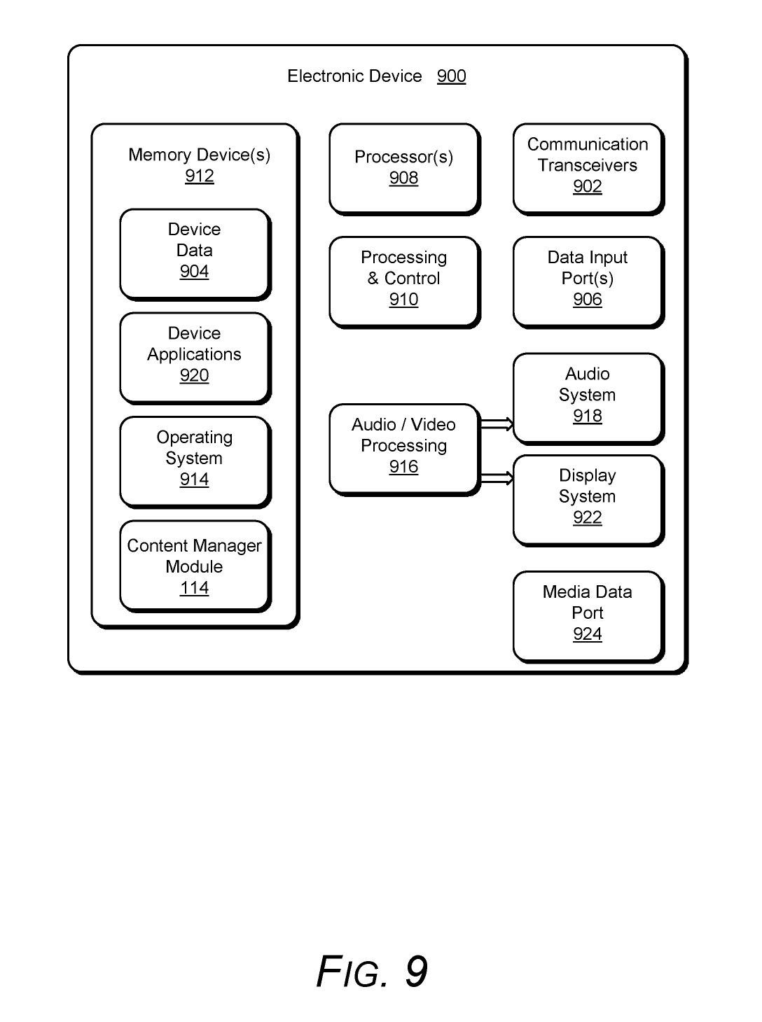

FIG. 9 illustrates various components of an example electronic device 900 that can be utilized to implement on-demand video surfing as described with reference to any of the previous FIGS. 1-8. The electronic device may be implemented as any one or combination of a fixed or mobile device, in any form of a consumer, computer, portable, user, communication, phone, navigation, gaming, audio, camera, messaging, media playback, and/or other type of electronic device, such as the video-rendering device 102 described with reference to FIGS. 1 and 2.

Electronic device 900 includes communication transceivers 902 that enable wired and/or wireless communication of device data 904, such as received data, transmitted data, or sensor data as described above. Example communication transceivers include NFC transceivers, WPAN radios compliant with various IEEE 902.15 (Bluetooth™) standards, WLAN radios compliant with any of the various IEEE 902.11 (WiFi™) standards, WWAN (3GPP-compliant) radios for cellular telephony, wireless metropolitan area network (WMAN) radios compliant with various IEEE 902.16 (WiMAX™) standards, and wired local-area-network (LAN) Ethernet transceivers.

Electronic device 900 may also include one or more data input ports 906 via which any type of data, media content, and/or inputs can be received, such as user-selectable inputs, messages, music, television content, recorded video content, and any other type of audio, video, and/or image data received from any content and/or data source (e.g., other video devices). Data input ports 906 may include USB ports, coaxial cable ports, and other serial or parallel connectors (including internal connectors) for flash memory, DVDs, CDs, and the like. These data input ports may be used to couple the electronic device to components (e.g., image sensor 102), peripherals, or accessories such as keyboards, microphones, or cameras.

Electronic device 900 of this example includes processor system 908 (e.g., any of application processors, microprocessors, digital-signal-processors, controllers, and the like), or a processor and memory system (e.g., implemented in a SoC), which process (i.e., execute) computer-executable instructions to control operation of the device. Processor system 908 may be implemented as an application processor, embedded controller, microcontroller, and the like. A processing system may be implemented at least partially in hardware, which can include components of an integrated circuit or on-chip system, digital-signal processor (DSP), application-specific integrated circuit (ASIC), field-programmable gate array (FPGA), a complex programmable logic device (CPLD), and other implementations in silicon and/or other hardware.

Alternatively or in addition, electronic device 900 can be implemented with any one or combination of software, hardware, firmware, or fixed logic circuitry that is implemented in connection with processing and control circuits, which are generally identified at 910 (processing and control 910).

Although not shown, electronic device 900 can include a system bus, crossbar, or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Electronic device 900 also includes one or more memory devices 912 that enable data storage, examples of which include random access memory (RAM), non-volatile memory (e.g., read-only memory (ROM), flash memory, EPROM, EEPROM, etc.), and a disk storage device. Memory device(s) 912 provide data storage mechanisms to store the device data 904, other types of information and/or data, and various device applications 920 (e.g., software applications). For example, operating system 914 can be maintained as software instructions within memory device 912 and executed by processors (e.g., processor system 908). In some aspects, content management module 114 is embodied in memory devices 912 of electronic device 900 as executable instructions or code. Although represented as a software implementation, content management module 114 may be implemented as any form of a control application, software application, signal-processing and control module, or hardware or firmware installed on the electronic device 900.

Electronic device 900 also includes audio and/or video processing system 916 that processes audio data and/or passes through the audio and video data to audio system 918 and/or to display system 922 (e.g., a screen of a smart phone or camera). Audio system 918 and/or display system 922 may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 924. In some implementations, audio system 918 and/or display system 922 are external components to electronic device 900. Alternatively or additionally, display system 922 can be an integrated component of the example electronic device, such as part of an integrated touch interface.

Although embodiment of methodologies for on-demand video surfing have been described in language specific to features and/or methods, the subject of the appended claims is not necessarily limited to the specific features or methods described. Rather, the specific features and methods are disclosed as example implementations of on-demand video surfing.

1. In a digital environment that supports on-demand video surfing by a video-rendering device, a method implemented by a service provider, the method comprising:
searching on-demand content based on search criteria associated with a user-generated search query to identify videos each having a scene corresponding to the search criteria;
providing access to full versions of the identified videos;
responsive to a first user input selecting a first video from the identified videos, causing the video-rendering device to play a full version of the first video via a first content stream beginning at the scene corresponding to the search criteria; and
responsive to a second user input selecting a second video from the identified videos, causing the video-rendering device to play a full version of the second video via a second content stream beginning at an additional scene corresponding to the search criteria, the second content stream being different than the first content stream.

2. (canceled)

3. A method as described in claim 1, wherein:
the providing access provides video IDs corresponding to the identified videos; and
causing the video-rendering device to play the first video at the scene provides the first video responsive to the first user input; and
causing the video-rendering device to play the second video at the additional scene provides the second video responsive to the second user input.

4. A method as described in claim 1, further comprising, prior to completion of playback of the scene in the first video, receiving the second user input selecting the second video, and wherein causing the video-rendering device to play the second video at the additional scene corresponding to the search criteria includes switching content streams from the first content stream to the second content stream.

5. A method as described in claim 1, wherein the search query specifies a type of action or event occurring in the scene.

6. A method as described in claim 1, wherein the user-generated search query is based on an audio input.

7. A method as described in claim 1, further comprising:
providing the first video as streaming content; and
responsive to completion of playback of the scene in the first video at the video-rendering device prior to receiving the second user input, automatically continuing streaming a remaining portion of the first video that is subsequent to the scene to cause the video-rendering device to play the remaining portion of the first video.

8. A method as described in claim 1, further comprising responsive to a user selection of a user interface instrumentality, cause the video-rendering device to play the second video at a beginning of the second video.

9. A method as described in claim 1, further comprising providing the first video or the second video to the video-rendering device as a time-shifted video to cause the video-rendering device to play the first video at the scene corresponding to the search criteria or the second video at the additional scene corresponding to the search criteria.

10. In a digital environment that supports on-demand video surfing by a video-rendering device, a service provider system comprising:
at least one computer-readable storage media storing instructions; and
at least one processor configured to execute the instructions to perform operations comprising:
searching on-demand content to identify videos having a scene corresponding to search criteria associated with a user-generated search query;
providing access to full versions of the identified videos;
responsive to a user input selecting a first video from the identified videos, causing the video-rendering device to play a full version of the first video via a first content stream beginning at the scene corresponding to the search criteria; and
responsive to second user input selecting second video from the identified videos, causing the video-rendering device to play a full version of the second video via a second content stream beginning at an additional scene corresponding to the search criteria, the second content stream being separate from the first content stream.

11. (canceled)

12. A system as described in claim 10, wherein the operations further include, responsive to the second user input selecting the second video by selecting a user interface instrumentality, causing the video-rendering device to play the second video at a beginning of the second video.

13. A system as described in claim 10, wherein the operations further include, responsive to completion of playback of the scene in the first video prior to receiving the second user input, automatically continuing playing at least a portion of the first video subsequent to the scene.

14. In a digital environment that supports on-demand video surfing by a video-rendering device, a method implemented by the video-rendering device, the method comprising:
receiving a search query specifying search criteria;
providing the search query to a server to search on-demand content for videos having a scene corresponding to the search criteria;
receiving access to full versions of a subset of the videos determined to have the scene corresponding to the search criteria;
responsive to a user input selecting a first video from the subset of videos, playing a full version of the first video via a first content stream beginning at the scene corresponding to the search criteria; and
responsive to an additional user input that selects a second video of the subset of videos, playing a full version of the second video via a second content stream beginning at an additional scene corresponding to the search criteria, the second content stream being different from the first content stream.

15. A method as described in claim 14, wherein the search query is received based on an audio input associated with a voice command.

16. A method as described in claim 14, further comprising, responsive to playback of the first video reaching an end of the scene in the first video prior to receiving the second user input, automatically playing a remaining portion of the first video subsequent to the scene.

17. (canceled)

18. A method as described in claim 14, wherein playing the first video includes time-shifting the full version of the first video to the scene.

19. A method as described in claim 14, wherein:
the videos in the subset of videos are each associated with a separate content stream;
the first video is played based on the first content stream starting at the scene; and
the second video is played based on the second content stream starting at the additional scene.

20. (canceled)

21. A method as described in claim 14, further comprising:
receiving the second user input during playback of the first video via the first content stream; and
causing the playback of the first video to cease.

22. A method as described in claim 14, further comprising, prior to completion of playback of the scene in the first video via the first content stream, receiving the second user input selecting the second video, and wherein playing the second video via the second content stream at the additional scene includes switching content streams from the first content stream to the second content stream prior to the completion of the playback of the scene in the first video.

23. A method as described in claim 1, further comprising time-shifting each of the identified videos to the scene corresponding to the search criteria prior to providing access to the full versions of the subset of the identified videos.

24. A system as described in claim 10, wherein:
the second user input is received during playback of the first video via the first content stream; and
the operations further include causing the playback of the first video to cease in response to the second user input being received.
